(19) United States
(12) Patent Application Publication
(10) Pub. No.: US 2025/0378234 A1
(43) Pub. Date: Dec. 11, 2025

(54) RESERVOIR SIMULATION METHOD ASSESSMENT USING DEEP CONVOLUTIONAL NEURAL NETWORKS

(71) Applicant: Saudi Arabian Oil Company, Dhahran (SA)

(72) Inventors: Ridwan Shams Jalali, Al Khobar (SA); Abdulaziz Mohammad Al-Darrab, Al Khobar (SA)

(21) Appl. No.: 18/738,555

(22) Filed: Jun. 10, 2024

(51) Int. Cl. G06F 30/27; G01V 20/00

(52) U.S. Cl. CPC G06F 30/27; G01V 20/00

(57) ABSTRACT

The present disclosure relates to computer-implemented methods, software, and systems for automatically assessing simulation results obtained from simulation to predict production of a reservoir. Simulation results and observed field data can be obtained based on executing a simulation model for predicting production of a reservoir in a field for a period of time. The observed field data is obtained from the field and for the reservoir in production during the period of time. A type of misfit of the simulation model can be determined when predicting the production. The one or more trained classifiers are trained to classify the type of misfit is based on an image processing of the observed field data and the simulation results. A modification is determined for the simulation model to adjust future simulation results to reduce the misfit of the simulation model. The simulation model is adjusted based on the determined modification.

### TECHNICAL FIELD

The present disclosure relates to computer-implemented methods, software, and systems for data processing.

### BACKGROUND

A reservoir simulation model can simulate past behavior of a reservoir in a process known as history match. Simulation engineers typically compare the simulation results with field data from an active reservoir to determine if there is misfit. The simulation engineer can determine whether there are required adjustments to the simulation model that reduce the misfit with field data. During this process, an engineer can review the quality of the field data and decide how to use it in the simulation.

### SUMMARY

The present disclosure involves systems, software, and computer implemented methods for automatically assessing simulation results obtained from an executed simulation model for predicting production of a reservoir. The assessments can be used to determine misfit in the simulation model and adjust the simulation model to reduce the misfit.

One example method may include operations such as obtaining simulation results and observed field data, wherein the simulation results are obtained based on executing a simulation model for predicting production of a reservoir in a field for a period of time, and wherein the observed field data is obtained from the field and for the reservoir in production during the period of time; determining, using one or more trained classifiers, a type of misfit of the simulation model when predicting the production, wherein the one or more trained classifiers are trained to classify the type of misfit is based on an image processing of the observed field data and the simulation results; in response to determining the type of the misfit, determining a modification for the simulation model to adjust future simulation results to reduce the misfit of the simulation model; and adjusting the simulation model based on the determined modification.

In some instances, the method can include training the one or more trained classifiers can include: obtaining initial raw data comprising observed field data and simulation results, wherein the simulation results are obtained by executing the simulation model; performing data transformation over the initial raw data to generate labeled training data; and training the one or more trained classifiers based on the labeled training data.

In some instances, performing the data transformation can include reading the observed field data and the simulation results in form of time series data. A plot image can be generated based on plotting the field data and the simulation results on a chart. The plot image can be sliced vertically into a plurality of image slices and the image slices can be rescaled to a particular resolution format. The rescaled image slices can be relabeled to indicate different types of misfit.

In some instances, the training of the one or more trained classifiers can include generating the labeled training data that can include: generating a first portion of the labeled training data to be used for the training of the one or more trained classifiers, and generating a second portion of the labeled training data to be used for testing the one or more trained classifiers after the training.

In some instances, the first and the second portions of the labeled training data can be generated by splitting the labeled training data according to a predefined ratio.

In some instances, the slicing of the plot images can be performed depending on a predefined period for dividing the data based on a time span associated with the training data.

In some instances, determining the type of misfit of the simulation model when predicting the production using the one or more trained classifiers can include: plotting the simulation results and the observed field data on a scale as an image; and processing the image using the one or more trained classifiers to identify a phenomenon in the plotted simulation results and the plotted observed field data, wherein the identified phenomenon is classified as the type of misfit.

Similar operations and processes may be performed in a system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations is also contemplated. In other words, while generally described as computer implemented software embodied on tangible, non-transitory media that processes and transforms the respective data, some or all of the aspects may be computer implemented methods or included in respective systems or other devices for performing this described functionality.

It is appreciated that methods, in accordance with the present disclosure, can include any combination of the aspects and features described herein. That is, methods in accordance with the present disclosure are not limited to the combinations of aspects and features specifically described herein, but also include any combination of the aspects and features provided.

The details of these and other aspects and embodiments of the present disclosure are set forth in the accompanying drawings and the description below. Other features, objects, and advantages of the disclosure will be apparent from the description, the drawings, and the claims.

### DESCRIPTION OF DRAWINGS

FIG. 1 illustrates an example computer system architecture for determining misfits of simulations methods.

FIG. 2A is a block diagram of an example method for determining a misfit of a simulation method.

FIG. 2B is a block diagram of an example method for training a machine learning model to determine misfit in a simulation model.

FIG. 3A is a block diagram of an example method for performing data transformation to generate training data.

FIG. 3B is a block diagram of an example architecture of a neural network for training classifiers.

FIG. 4 is a flowchart of an example of phenomena when comparing simulation result data with observed data.

FIG. 5 is a schematic illustration of example computer systems that can be used to execute implementations of the present disclosure.

### DETAILED DESCRIPTION

The present disclosure describes various tools and techniques for assessing misfit of a reservoir simulation model (e.g., a simulation model that reproduces the past behavior of a reservoir in a process such as a history match process) that can be used to adjust the simulation model to improve the model's accuracy. The misfit can be classified by identifying a type of misfit using a trained model for assessing simulation results based on historical data. The assessment of the misfit can be performed according to trained classifiers using image classification. The misfit can be a misfit of predicted production of a reservoir according to the simulation model, where the production can be a measurable quantity of oil, water, gas, pressure, or other fluid in the reservoir.

In some instances, reservoir modeling can involve the construction of a computer model of the reservoir (e.g., petroleum reservoir) that can be used to estimate production and support development of the reservoir. Future production can be predicted so that additional wells can be placed and/or modifications or alternations of the reservoir management can be evaluated. A reservoir model can represent a physical space of the reservoir and can be a two-dimensional or three-dimensional model defined as an array of cells over a grid. In some instances, the cells of the model can be associated with values of attributes such as porosity, permeability, and/or water saturation. The value of such attributes can apply (e.g., uniformly or according to attributes assignment) throughout a volume of the reservoir represented by a cell.

In general, reservoir simulation models can be created by using difference finite methods to simulate the flow of fluids within a reservoir over their production lifetime. Using the simulation, flow of fluids through porous media can be predicted. The reservoir model can be associated with static or dynamic variables that, during simulation, can be updated to match real-time production data. In some instances, a reservoir simulation model can be generated to reproduce past behavior of a reservoir during a history matching process. History matching is the process of building models representing a reservoir to account for observed data measured in the field. In some cases, simulation data and field data can be line-plotted and based on observed misfit (e.g., observed visually) and a type of the misfit can be determined. According to the determined type of misfit, the simulation model can be adjusted to reduce the misfit of the simulation result. The process of determining the misfit can be time consuming and may require engineering expertise. Further, the determination of misfit may be associated with processing large volumes associated with multiple wells, groups, and aggregated field data for properties of the reservoir (e.g., pressure, oil/water/gas production rate, water/gas injection rate, other).

In some instances, simulation results can be plotted with observed field data as time series data in a chart area (e.g., coordinate system) and, based on visually assessing the differences between observed and predicted data, a misfit can be classified. The identification of a misfit in an image including plotted data (including simulation result data and observed data) can be used to adjust the simulation model. For example, the simulation model can be adjusted to reduce the misfit with the real field data so as to improve the accuracy of the prediction of the performance of the reservoir in real-time. The assessment of the misfit of the simulation model can be defined as a visual comparison problem that includes evaluation of simulation result data and observed field data as time-series data that can be plotted on a scale and analyzed based on image comparison. The classifiers can be trained to classify a type of the misfits in an automatic and accurate manner that reduces resource expenses compared to use cases that involve manual classification done by engineers that can be time consuming and can be error prone and subject to the expertise of particular engineers.

In some instances, the classifiers can be trained using training data that includes transformed image data. The image data can be generated from the plotted data on a scale or chart in accordance with implementations of the present disclosure. The observed and simulated data can be collected and plotted, one over the other, on the scale or chart so that images of the representation can be generated. The images can be used to train a classifier to compare differences between the simulated and observed occurrences and identify phenomena in the patterns of the data.

The trained classifiers can be used to automate a classification problem of determining a type of misfit of a simulation model. The misfit can be used to efficiently alter the simulation model, e.g., in an automated way. In accordance with implementations of the present disclosure, the simulation results and the observed field data can be visualized at runtime and the comparison as plotted images can be presented with an accurate classification of the type of misfit of the simulation model.

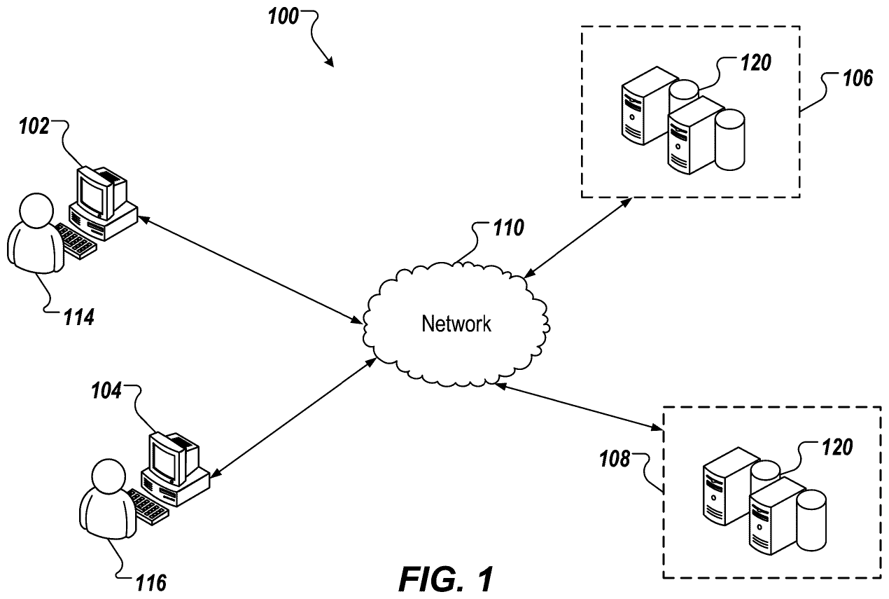

FIG. 1 depicts an example architecture 100 in accordance with implementations of the present disclosure. In the depicted example, the example architecture 100 includes a client device 102, a client device 104, a network 110, an environment 106, and an environment 108. The environment 106 and the environment 108 may be a cloud environment. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device such as a desktop computer, a laptop computer, a handheld computer, a tablet computer, a personal digital assistant (PDA), a cellular telephone, a network appliance, a camera, a smartphone, an enhanced general packet radio service (EGPRS) mobile phone, a media player, a navigation device, an email device, a game console, or an appropriate combination of any two or more of these devices, or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the environment 106 includes at least one server and at least one data store 120. In the example of FIG. 1, the environment 106 is intended to represent various forms of servers including, but not limited to a web server, an application server, a proxy server, a network server, and/or a server pool. In general, server systems accept requests for application services and provides such services to any number of client devices (e.g., the client device 102 over the network 110) and other service requests, as appropriate.

In some instances, the environments 106 and 108 may host one or more client applications, application servers, and authorization servers to support execution of secure requests between the client applications and the application server. In some instances, the users 114 and/or 116 may access a client application through the network 110.

In some instances, the client devices 102 and/or 104 can host logic for running simulation models and for executing automatic classification of misfit of one or more of the simulation models. The misfit can be used to adjust the simulation models to more accurately predict reservoir measurable quantities.

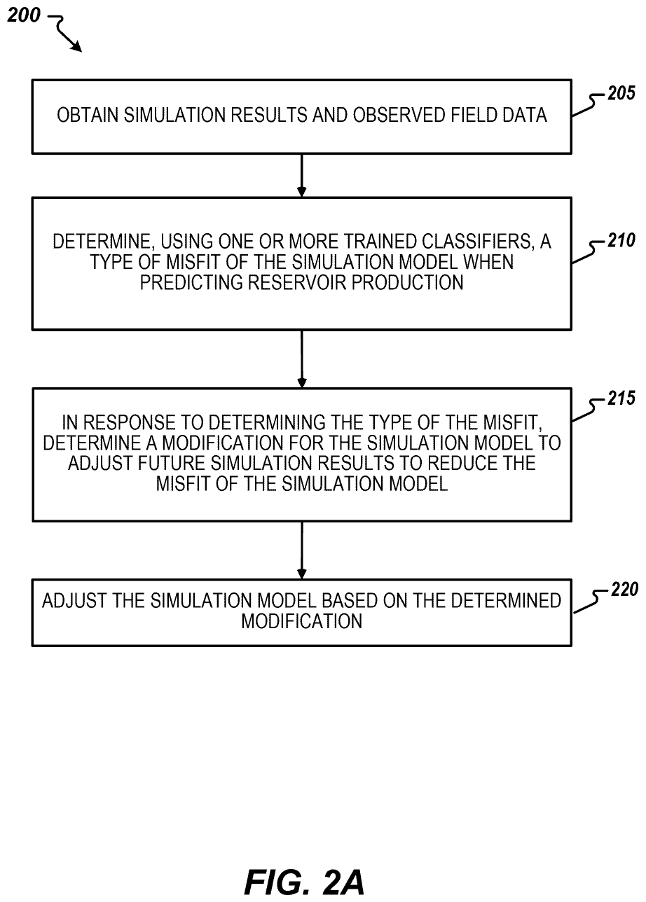

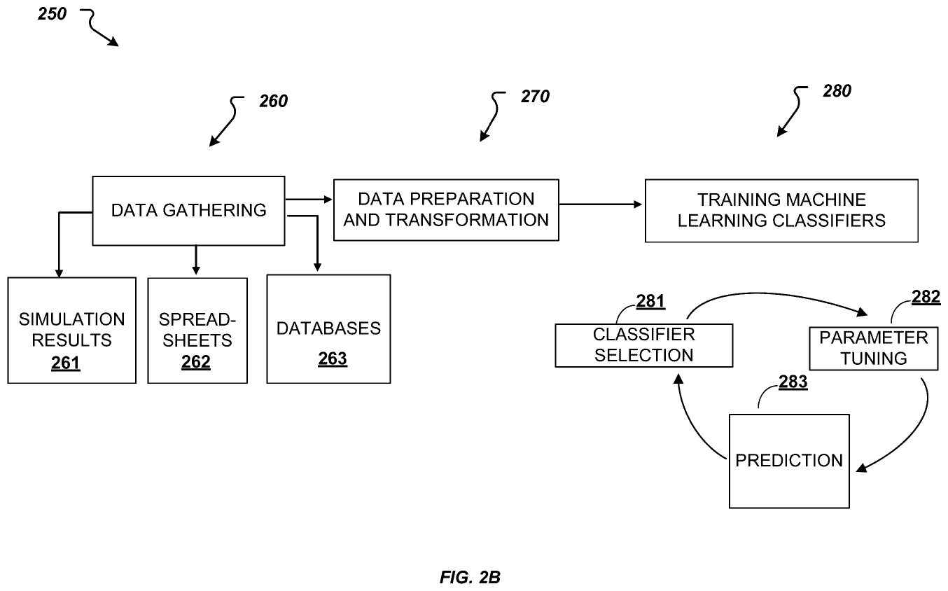

FIG. 2A is a block diagram of an example method 200 for determining a misfit of a simulation method. The method 200 can be executed at a computing environment, for example, such as the environment 106 and/or 108. The method 200 can be executed to evaluate simulation results of a running simulation method when measuring quantities of a reservoir, e.g., oil, water, gas, or other fluids. By evaluating the simulation results and determining misfit of the simulation model, the parameters of the simulation model can be fine-tuned and thus the model can be improved to predict future reservoir quantities more accurately.

At 210, simulation results and observed field data are obtained. The simulation results are obtained by executing a simulation model for predicting production of a reservoir in a field for a period of time. The observed field data can be obtained from the field, for the reservoir in production during the period of time. In some instances, the evaluation of the simulation results and respective observed field data can be performed according to a predefined time schedule (e.g., regular or irregular) or based on a detected event invoking a fine-tuning at the simulation model.

At 215, a type of misfit of the simulation model when predicting the reserves of the reservoir can be determined. The determination of the type of misfit can be performed by using one or more trained classifiers. The one or more trained classifiers can be trained to classify the type of misfit based on image processing of the observed field data and the simulation results.

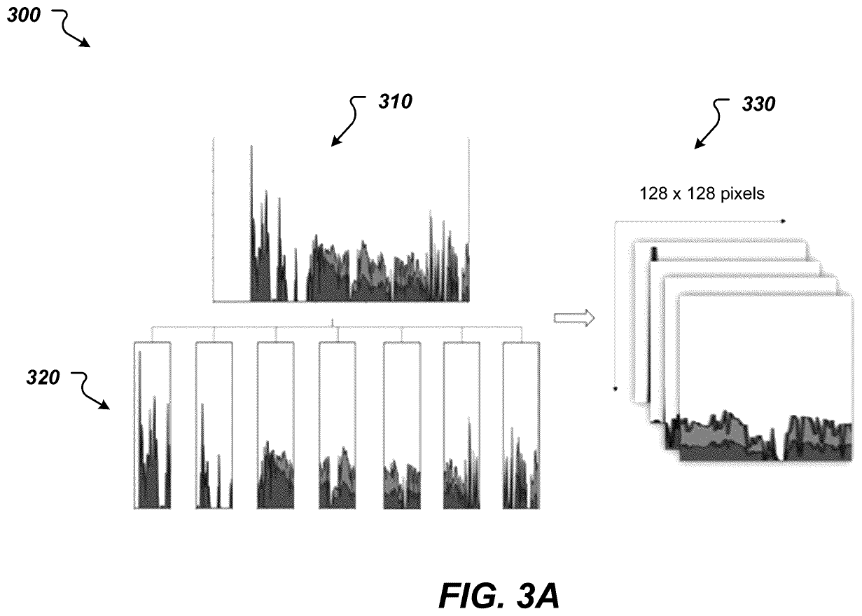

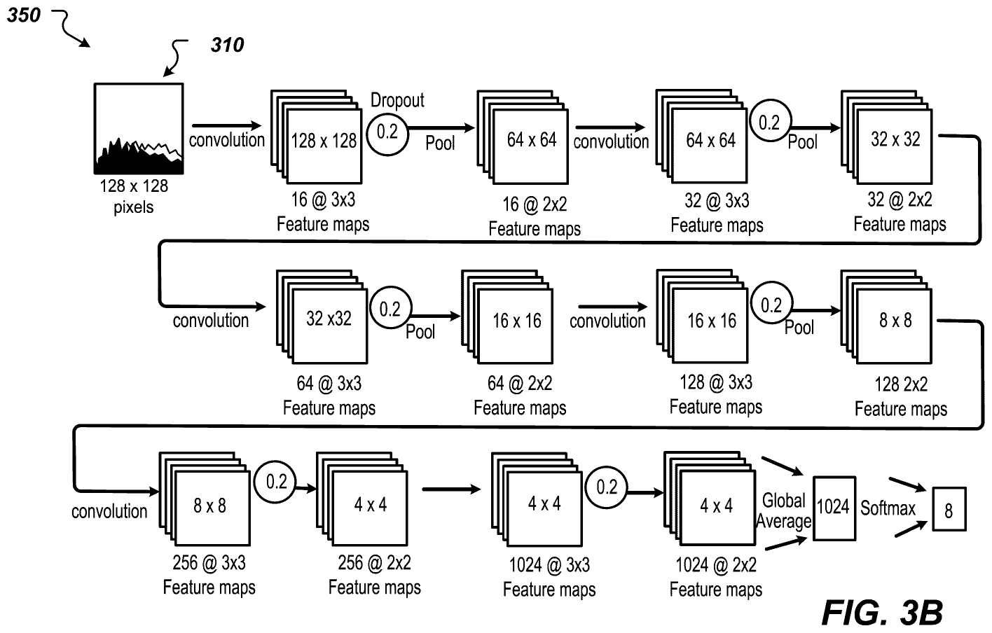

In some instances, the one or more trained classifiers are trained based on training data obtained from the field and from the simulation model. The training data can be generated based on obtained initial raw data comprising observed field data and simulation results. The raw data can be transformed and labeled training images can be generated, for example, as described in more detail in relation to FIG. 3A.

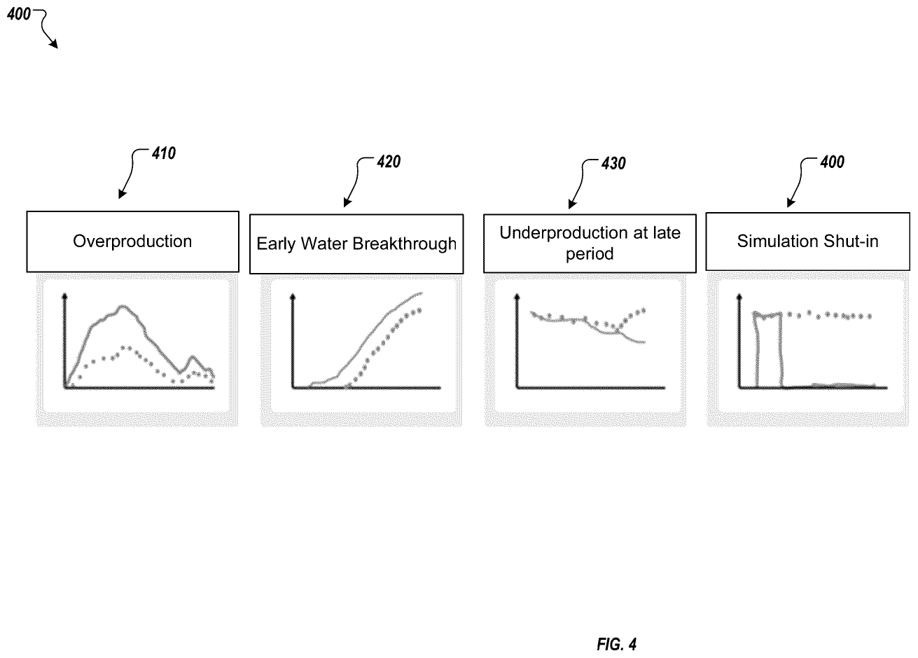

The processing of the initial raw data to generate training data and determine the type of misfit can include plotting the simulation results and the obtained field data on a scale (e.g., on a coordinate system having time along the x-axis and the measured quantities of the reservoir along the y-axis) and processing the plotted data as an image. The one or more trained classifiers can identify a phenomenon in the plotted data based on processing the image and identifying the misfit by classifying the identified phenomenon as a type of the misfit. For example, many different phenomena can be captured, such as, those shown on FIG. 4 and including overproduction, early breakthrough, underproduction at late period, simulation shut-in, etc.

At 220, in response to determining the type of the misfit, a modification of the simulation model can be determined. Using the modification, the simulation model can be adjusted and future simulation results can be closer to observed data. Thus, observed misfit of the simulation model can be reduced.

At 225, the simulation model can be adjusted based on the determined modification. In some instances, the determined type of the misfit can be provided for display at a display device together with real-time visualization of the simulated and observed field data. In cases where the simulation model is adjusted to address an identified misfit, the visualization of the plotted data and the determined misfit can be adjusted to correspond to the adjusted simulation model and classification. In some instances, the adjusted simulation model can be used for further retraining or training of classifiers to improve the classification accuracy. In some instance, the retraining (or training) can be associated with training for identifying other types of misfit that were included in previous training.

FIG. 2B is a block diagram of an example method 250 for training a machine learning model to determine misfit in a simulation model. The example method 250 can be applied to train classifiers such as those used to determine a misfit at operation 210 of the method 200 of FIG. 2A.

In some instances, training a machine learning model, such as a machine learning classifier (or classifier), can include multiple operations. The operations can include determining training data to be used for training and selecting a model to be trained.

At 260, initial raw data to be used for the training can be gathered. The gathered data includes simulation results 261 and observed field data. The observed field data can be production data collected from the field, for example, from different wells where observed data can include observations of many phenomena of interest (e.g., overproduction). The simulation results 261 are obtained from executing a simulation model that is evaluated so that the model can be modified and fine tuned to changes observed during production. The observed field data can be obtained from databases 263 or from other data sources such as spreadsheets and text files 262 or other data files of other formats.

At 270, the obtained raw data can be processed to generate training image data for use during a training phase. The processing includes data preparation and transformation operations. The simulation results and the observed field data are read from the different data sources (as defined at 260) and are plotted in the form of time series data over a scale (or a chart) to generate plots that can be stored as images and used to train machine learning model(s). The plotted images can be sliced, rescaled to a predefined resolution format, and input to a neural network to train classifiers to identify misfit of the simulation model.

In some instances, during the data preparation, when the data from the simulation and from production is plotted on a scale, the visual representation of the plotted data (e.g., as shown at 310 of FIG. 3A) can be stored as images. For example, simulation data and observed field data associated with a matching time period can be plotted on a scale and the visualized overlay of the data can be stored as an image. Multiple images can be created that are associated with different time periods that can be overlapping or distinct. A time period used for comparing and plotting the data can be predefined in relation to the simulation model and a type of data (e.g., producing oil, water, or other fluid) that is predicted. For example, for an oil reservoir that has been productive for 50 years, a five-year window would be sufficient for analysis to identify a type of mismatch between simulated and observed data.

In some instances, as part of the data preparation and transformation, the generated images can be sliced vertically so that multiple sub-images (e.g., as shown at 320 of FIG. 3A) can be transformed and used to train machine learning models, for example, as described in relation to FIG. 2A and FIG. 3A. The image slices can be rescaled to an image of a particular resolution (e.g., 128×128 pixels image). The rescaled image slices can be labeled with a particular misfit that is observed in the particular image slice. For example, the labeling can be performed manually by an expert in the field. The labelled data can be split into two portions: 1) training data to be used when training a classifier to determine misfit and 2) testing data to be used to evaluate the performance of the classifier being trained.

At 280, the training data generated at 270, can be used in training the machine learning classifiers to automatically categorize a misfit of a simulation model. In some instances, a classifier 281 to be trained can be selected. Parameters of the classifier can be tuned based on observing field data and comparing the field data with simulated predicted results as described herein. Classifier's parameters can be fine-tuned at 282 and a prediction for the expected misfit of the simulation model can be provided at 283. The prediction for the expected misfit can be used to refine the simulation model so that it is adjusted to provide more accurate predictions corresponding to observed phenomena at the reservoir in the field.

FIG. 3A is a block diagram of an example method 300 for performing data transformation to generate training data. The method 300 can be performed as part of the data preparation and transformation operations described in relation to step 270 of FIG. 2B.

In some instances, simulation results can be obtained from an executed simulation model that is defined to predict field data. For example, the simulation simulate a petroleum reservoir to determine productive rates. However, simulation results may differ from observed data and thus the simulation model may need to be adjusted. The simulation results obtained from the executed simulation model together with observed field data for a respective period of time can be obtained and used to train a neural network. Classifiers can be built and trained to classify a misfit of the simulation model that can be used to adjust the simulation model.

In some instances, simulation data and observed data can be plotted one over the other on a scale, such as a coordinate system, and stored as an image 310. For example, the simulated production/injection rates of wells can be plotted against field-measured rates and pressure in a semi-transparent area chart as shown on image 310. The simulation data can be obtained from a simulation model that is evaluated and is relevant for training classifiers that can automatically classify misfit of the simulation model. The simulation can be performed for one or more wells over different points in time. Respective field data from the well can be also collected and mapped to the simulation results. The differences can be analyzed. In some instances, the plotted data can be aggregated simulation and observed data for groups of wells or field level quantities. For example, the data can be aggregated according to an aggregation method such as average, mean, weighted average, or other.

In some instances, the determination of a misfit of a simulation model can be performed automatically based on trained classifiers as described in relation to FIGS. 2A and 2B. For training the classifiers, training data including the simulation data and the observed data can be obtained. The generated training data include simulated and real-productive results, for example, as discussed in relation to FIG. 2B. The simulated data and the observed (real-productive data) can be associated with the same time period, for example, a number of years. The simulation data and the observed data can be plotted as time series data one over the other on a scale, such as a coordinate system, where, for given time points, there are both a simulated value and an observed value. The plotted data can be stored as an image 310, where the image can used for the training of classifiers to classify misfit of the simulation method. The training can be based on image processing of images that show both simulation results and observed data.

The image 310 can be sliced into a number of vertical slices, such as slice 320. The number of slices into what the image 310 is divided can be determined based on a selected time period to be used for a slice. When the slice is evaluated, the slice size (time period span) can be associated with higher chances of detecting a phenomenon of interest in the reservoir. For example, the time period for a slice can be preselected for a given reservoir or reservoir property (e.g., fluid, location, size, etc.). In some instances, the image 310 is divided into a number of slices defined in a way to reasonably expect that a phenomenon in the compared data will be distinguished. For example, if the data—both simulation and observed data—is plotted for a period of years, for example, for more than 50 years, then the periods into what the image 310 c is sliced an be defined to be five years since five years would be sufficient to identify a type of a misfit (corresponding to a data phenomenon in the difference between the observed and the simulated data).

In some instances, when the data is sliced, the vertical image portions can be of a given image format and each image, such as, e.g., a sliced image 320 corresponding to a slice of the image 310, can be classified. The sliced image 320 can be labeled so that the labeled data can be used for the training. The labeling of the sliced images can be performed by a domain-expert or qualified software provider. The labeling of the slices can annotate the slices with a data phenomenon that is observed at the slice. Different data phenomenon can be defined and used for the labeling, for example, as discussed in more detail in relation to FIG. 4. The data phenomenon can be defined as a pattern observed for the difference of data occurrences in simulated and observed data.

When the slices of the image 310 are generated, modified sliced images 330 are generated. The modified sliced images 330 are modified by rescaling according to a predefined resolution format, for example, 128 pixels to 128 pixels. The rescaled sliced images can be used for the training of classifiers to automatically determine misfit of a simulation model. The rescaled sliced images can be labeled to indicate different types of misfit, where the labeling can be performed by identifying a phenomenon in the respective image slice and classifying it as a type of misfit. The respective types of misfit and corresponding phenomenon can be predefined for labeling of the rescaled sliced images. The training can be performed for classifying according to a set of types of misfit. In some instances, a modified set of the types of misfit can be defined. More training data can be used and labeled with types of the modified set. The classifiers can be retrained using the modified set of types of misfit. In some instances, the modified set of the types can be a set that includes more or different types of classifiers compared to those used for a previous training.

In some instances, the labeled, sliced, and rescaled images 330 can be divided into two portions, where a first portion is used for performing the training and a second portion is be used for evaluating the result of the classifiers after the training. The division into two groups can be performed according to a predefined division ratio, for example, 80% for training and 20% for testing.

FIG. 3B is a block diagram of an example architecture 350 of a neural network for training classifiers. In some instances, a classifier can be trained as described in relation to FIG. 2B based on training data generated as described in relation to FIG. 3B. In some instances, training data 335 is provided as input to the neural network, where the training data 335 can be a first portion defined from the generated sliced, rescaled, and labeled data 330 of FIG. 3A.

In some instances, to identify misfit in a simulation model in accordance with implementations of the present disclosure, a convolutional neural network (CNN) can be used to build one or more classifiers that are trained based on image training data. The CNN can be built of a particular architecture that includes several growing layers to train the classifier(s) to produce acceptable classification results for the misfit. The neural network can be defined to include convolutional layers that include an output layer of a size equal to the number of classifications of phenomena or misfit that can be provided by the trained classifiers.

The example architecture 350 includes convolutional layers with a dense output layer 360 that has a size equal to eight. This corresponds to the number of types of misfit for which the classifiers are trained. The convolutional network uses dropout layers that are set to probability of dropping of maximum 0.2. Multiple trainings can be performed using the training data that includes the rescaled sliced images 330 that are labeled as described in relation to FIG. 3A. In some instances, the training data 330 can be divided into two portions where the first portion can be used for the initial training, and the second portion can be used for evaluation of the trained classifiers based on the training.

In some instances, the architecture 350 can include several convolutional layers having a respective number of filters of a respective filter size and an activation function(s). In some instances, the architecture 350 can be built to include an optimal number of convolutional layers to form a deep convolutional network that includes multiple layers and that is designed for classifying misfit based on image classification. In some instances, the convolution network can be set with different parameters such as hyperparameters including dropout probability, number of epochs, learning rates, regularization techniques, and optimizer type. In some instances, adding dropout regularization, e.g., with dropout probability of 0.2, can be advantageous for the classifier's generalization capabilities. When the training is performed, the testing portion of the data 330 can be used to calculate the accuracy of the classifiers to assign a correct corresponding label to each image that corresponds to the labeling in the testing portion.

FIG. 4 is a flowchart of an example of phenomena when comparing simulation result data with observed data. In some instances, when simulation data and observed field data are evaluated as described in the present disclosure, misfit of simulation results can be classified into one of multiple categories that correspond to a data phenomenon observed for the differences between the simulated and observed data. A phenomenon can be considered as any pattern in a plot of simulated results and observed field data that can be attributed to a physical event in the field or well. In some instances, phenomena can be observed for periods of time during which the differences between the simulated results and the observed data follow a given trend, for example, as shown at 410, 420, 430, and 440. Other phenomena can be observed, and those can be used to train classifiers to classify observed differences between simulated and observed data as a respective misfit, as discussed in relation to FIGS. 2A, 2B, 3A, and 3B.

At 410, simulation results predict production that is higher than the observed field data and, as such, the curve corresponding to the simulation results (the full line curve) is above than the observed field data (the dotted line curve). If values from the simulation results are above than the observed field data. The a type of misfit in the simulation model can be classified as overproduction.

At 420, the simulation results are determined to have a trend of increase of the production values that matches the real result data. The predicted values and the observed values show higher production rates (e.g., above a threshold) earlier over time (e.g., within a threshold period over the production life), while the predicted values are forecasting earlier water (or other fluid) breakthrough compared to the observed values. For example, when the simulation model shows a water breakthrough (e.g., water cut>5%) few years earlier than the actual observed data, then the phenomena of the differences between the simulation results and the observed data can be categorized as an “early water breakthrough” phenomena (misfit). In some instances, based on determining such data phenomena and relating it to a misfit of the simulation model, the simulation model can be modified to delay the water from reaching the well by modifying parameters of the model such as, modifying parameters to reduce the permeability around the wellbore, to reduce the conductivity of nearby fractures, or other appropriate parameters that when used to simulate results would show a delay in the water breakthrough compared to previous results. The actions would depend on the uncertainties in the simulation model.

At 430, the simulation and the observed data diverge at the end of the observed period and the misfit of the simulation model can be classified as underproduction at a late period. In the example of 430, the simulation results are lower compared to the observed field data from the field at a latest portion of the time frame for the comparison, where the observed and the simulated data substantially match during the earlier portion of the time.

At 440, the observed field data shows relatively steady production rates, while the simulated results show a drastic decrease of the production. Such a data phenomenon can be classified as “simulation shut-in” misfit.

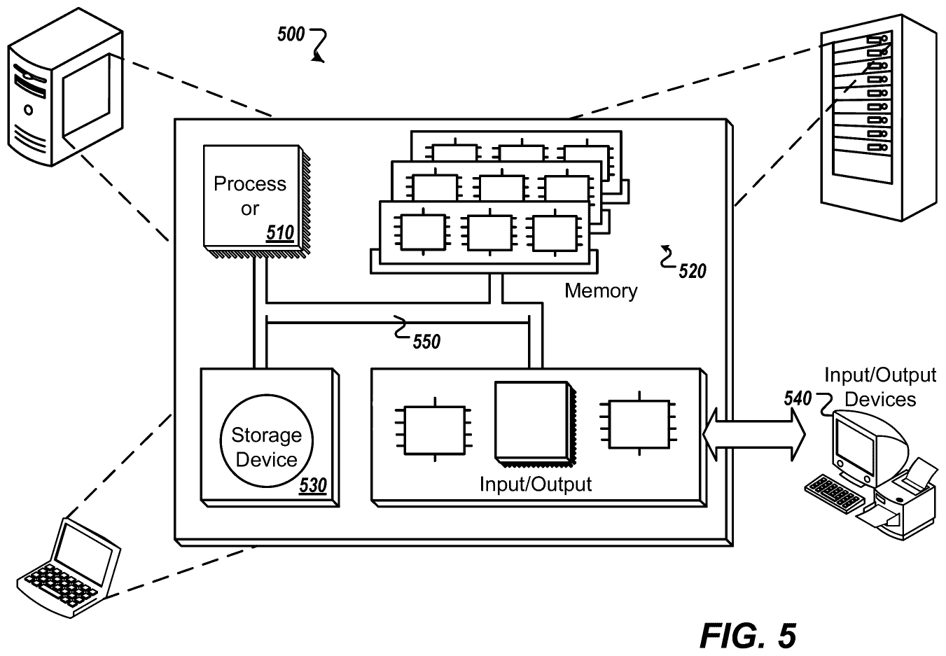

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, and 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory, a random access memory, or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated into application-specific integrated circuits (ASICs).

To provide for interaction with a user, the features can be implemented on a computer having a display device, such as a cathode ray tube (CRT) or liquid crystal display (LCD) monitor for displaying information to the user and a keyboard and a pointing device, such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication, such as a communication network. Examples of communication networks include, for example, a LAN, a WAN, and the computers and networks forming the Internet.

The computer system can include clients and servers. A client and server are generally remote from each other and typically interact through a network, such as the described one. The relationship of the client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

In view of the above described implementations of the subject matter, this application discloses the following list of examples, wherein one feature of an example in isolation or more than one feature of said example taken in combination and, optionally, in combination with one or more features of one or more further examples are further examples also falling within the disclosure of this application.

What is claimed is:

1. A computer implemented method comprising:
obtaining simulation results and observed field data, wherein the simulation results are obtained based on executing a simulation model for predicting production of a reservoir in a field for a period of time, and wherein the observed field data is obtained from the field and for the reservoir in production during the period of time;
determining, using one or more trained classifiers, a type of misfit of the simulation model when predicting the production, wherein the one or more trained classifiers are trained to classify the type of misfit is based on an image processing of the observed field data and the simulation results;
in response to determining the type of the misfit, determining a modification for the simulation model to adjust future simulation results to reduce the misfit of the simulation model; and
adjusting the simulation model based on the determined modification.

2. The method of claim 1, wherein the method comprises training the one or more trained classifiers comprising:
obtaining initial raw data comprising observed field data and simulation results, wherein the simulation results are obtained by executing the simulation model;
performing data transformation over the initial raw data to generate labeled training data; and
training the one or more trained classifiers based on the labeled training data.

3. The method of claim 2, wherein performing the data transformation comprises:
reading the observed field data and the simulation results in form of time series data;
generating a plot image based on plotting the field data and the simulation results on a chart;
slicing the plot image vertically into a plurality of image slices;
rescaling the image slices to a particular resolution format; and
labeling the rescaled image slices to indicate different types of misfit.

4. The method of claim 2, wherein the training comprises:
generating the labeled training data comprises:
generating a first portion of the labeled training data to be used for the training of the one or more trained classifiers, and
generating a second portion of the labeled training data to be used for testing the one or more trained classifiers after the training.

5. The method of claim 4, wherein the first and the second portion of the labeled training data are generated by splitting the labeled training data according to a predefined ratio.

6. The method of claim 3, wherein the slicing of the plot images is performed depending on a predefined period for dividing the data based on a time span associated with the training data.

7. The method of claim 1, wherein determining the type of misfit of the simulation model when predicting the production using the one or more trained classifiers comprises:
plotting the simulation results and the observed field data on a scale as an image; and
processing the image using the one or more trained classifiers to identify a phenomenon in the plotted simulation results and the plotted observed field data, wherein the identified phenomenon is classified as the type of misfit.

8. A non-transitory computer-readable medium coupled to one or more processors and having instructions stored thereon which, when executed by the one or more processors, cause the one or more processors to perform operations, the operations comprising:
obtaining simulation results and observed field data, wherein the simulation results are obtained based on executing a simulation model for predicting production of a reservoir in a field for a period of time, and wherein the observed field data is obtained from the field and for the reservoir in production during the period of time;
determining, using one or more trained classifiers, a type of misfit of the simulation model when predicting the production, wherein the one or more trained classifiers are trained to classify the type of misfit is based on an image processing of the observed field data and the simulation results;
in response to determining the type of the misfit, determining a modification for the simulation model to adjust future simulation results to reduce the misfit of the simulation model; and
adjusting the simulation model based on the determined modification.

9. The non-transitory computer-readable medium of claim 8, wherein the operations comprise training the one or more trained classifiers comprising:
obtaining initial raw data comprising observed field data and simulation results, wherein the simulation results are obtained by executing the simulation model;
performing data transformation over the initial raw data to generate labeled training data; and
training the one or more trained classifiers based on the labeled training data.

10. The non-transitory computer-readable medium of claim 9, wherein performing the data transformation comprises:
reading the observed field data and the simulation results in form of time series data;
generating a plot image based on plotting the field data and the simulation results on a chart;
slicing the plot image vertically into a plurality of image slices;
rescaling the image slices to a particular resolution format; and
labeling the rescaled image slices to indicate different types of misfit.

11. The non-transitory computer-readable medium of claim 9, wherein the training comprises:
generating the labeled training data comprises:
generating a first portion of the labeled training data to be used for the training of the one or more trained classifiers, and
generating a second portion of the labeled training data to be used for testing the one or more trained classifiers after the training.

12. The non-transitory computer-readable medium of claim 11, wherein the first and the second portion of the labeled training data are generated by splitting the labeled training data according to a predefined ratio.

13. The non-transitory computer-readable medium of claim 10, wherein the slicing of the plot images is performed depending on a predefined period for dividing the data based on a time span associated with the training data.

14. The non-transitory computer-readable medium of claim 8, wherein determining the type of misfit of the simulation model when predicting the production using the one or more trained classifiers comprises:
plotting the simulation results and the observed field data on a scale as an image; and
processing the image using the one or more trained classifiers to identify a phenomenon in the plotted simulation results and the plotted observed field data, wherein the identified phenomenon is classified as the type of misfit.

15. A system comprising
a computing device; and
a computer-readable storage device coupled to the computing device and having instructions stored thereon which, when executed by the computing device, cause the computing device to perform operations, the operations comprising:
obtaining simulation results and observed field data, wherein the simulation results are obtained based on executing a simulation model for predicting production of a reservoir in a field for a period of time, and wherein the observed field data is obtained from the field and for the reservoir in production during the period of time;
determining, using one or more trained classifiers, a type of misfit of the simulation model when predicting the production, wherein the one or more trained classifiers are trained to classify the type of misfit is based on an image processing of the observed field data and the simulation results;
in response to determining the type of the misfit, determining a modification for the simulation model to adjust future simulation results to reduce the misfit of the simulation model; and
adjusting the simulation model based on the determined modification.

16. The system of claim 15, wherein the operations comprises training the one or more trained classifiers comprising:
obtaining initial raw data comprising observed field data and simulation results, wherein the simulation results are obtained by executing the simulation model;
performing data transformation over the initial raw data to generate labeled training data; and
training the one or more trained classifiers based on the labeled training data.

17. The system of claim 16, wherein performing the data transformation comprises:
reading the observed field data and the simulation results in form of time series data;
generating a plot image based on plotting the field data and the simulation results on a chart;
slicing the plot image vertically into a plurality of image slices;
rescaling the image slices to a particular resolution format; and
labeling the rescaled image slices to indicate different types of misfit.

18. The system of claim 16, wherein the training comprises:
generating the labeled training data comprises:
generating a first portion of the labeled training data to be used for the training of the one or more trained classifiers, and
generating a second portion of the labeled training data to be used for testing the one or more trained classifiers after the training.

19. The system of claim 18, wherein the first and the second portion of the labeled training data are generated by splitting the labeled training data according to a predefined ratio.

20. The system of claim 17, wherein the slicing of the plot images is performed depending on a predefined period for dividing the data based on a time span associated with the training data.
